(19) United States
(12) Patent Application Publication
(10) Pub. No.: US 2005/0092554 A1
(43) Pub. Date: May 5, 2005

(54) Point-of-sale merchandising system

(76) Inventors: Frank McGillin, Bellevue, WA (US); Maarten Barmentlo, Baarn (NL); Flavia Albuquerque, Issaquah, WA (US)

Correspondence Address: PHILIPS INTELLECTUAL PROPERTY & STANDARDS, P.O. BOX 3001, BRIARCLIFF MANOR, NY, 10510, US

(21) Appl. No.: 10/965,507

(22) Filed: Oct. 14, 2004

Related U.S. Application Data
(60) Provisional application No. 60/516,171, filed on Oct. 31, 2003.

(51) Int. Cl. B61B 1/00; B65G 1/00; E04H 3/00; B65D 5/00

(52) U.S. Cl. 186/52

(57) ABSTRACT

The system comprises a product package which has a front side and an opposing rear side, designed to form two related but different front panels. Both panels include a picture of the product and key information about the product, presented in a similar, complementary format and appearance. Trademarks have a similar position and format on both panels, such that the second front panel (the rear side) presents an overall complementary appearance to the first front panel (the front side).

### CROSS REFERENCE TO RELATED CASES

Applicants claim the benefit of Provisional Application Ser. No. 60/516,171, filed Oct. 31, 2003.

### TECHNICAL FIELD

This invention relates generally to product packaging, and more specifically concerns a particular product package design which in turn permits a new pallet stack arrangement comprising a plurality of the product packages.

### BACKGROUND OF THE INVENTION

Traditional product packages (i.e. boxes) include front and back panels which are not only independent of each other in form and content but which are clearly distinguishable, with the front panel being the main panel of the package and the back panel being of lesser importance, with at least some of the information therein not being typically found on traditional front panels. Such packages are often arranged on pallets for consumer display of the product, involving relatively large numbers of the boxes (100-200 typically), stacked to display the front panel of the boxes and/or the side panels, but typically not the back panels. The resulting pallet has an extreme uniformity of appearance and is limited in the amount of information provided.

### SUMMARY OF THE INVENTION

Accordingly, the present invention is a merchandising system for product packages, comprising: a product package for a product, having a front side and an opposing rear side, wherein the content, format and design for both the front side and the rear side are like that of a conventional product package front panel, such that said product package gives the appearance of having two front panels instead of a front panel and a rear panel.

### BRIEF DESCRIPTION OF THE DRAWING

FIG. 1 is a perspective view of a pallet arrangement using the product package of the present invention.

FIG. 2 shows one of the “front panels” of the product package of the present invention.

FIG. 3 shows the other “front panel” of the product package of the present invention.

### BEST MODE FOR CARRYING OUT THE INVENTION

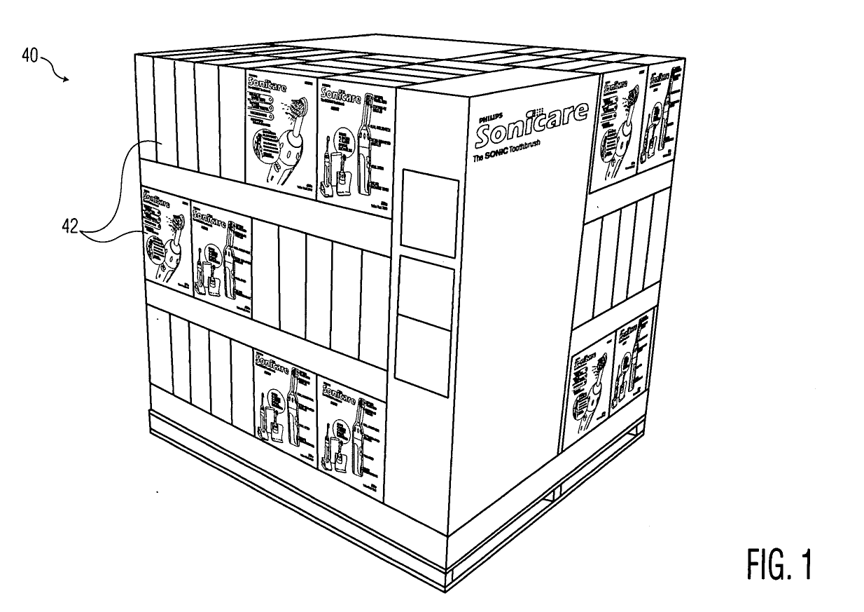

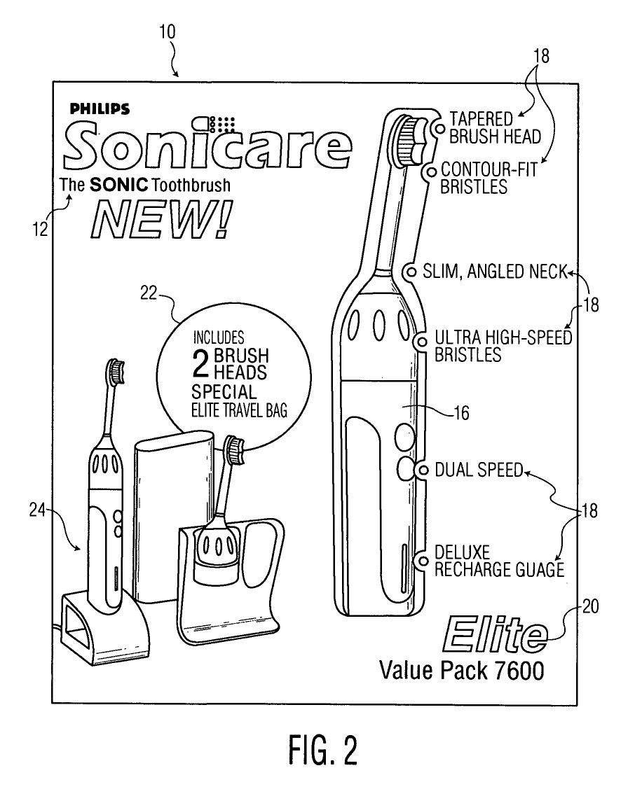

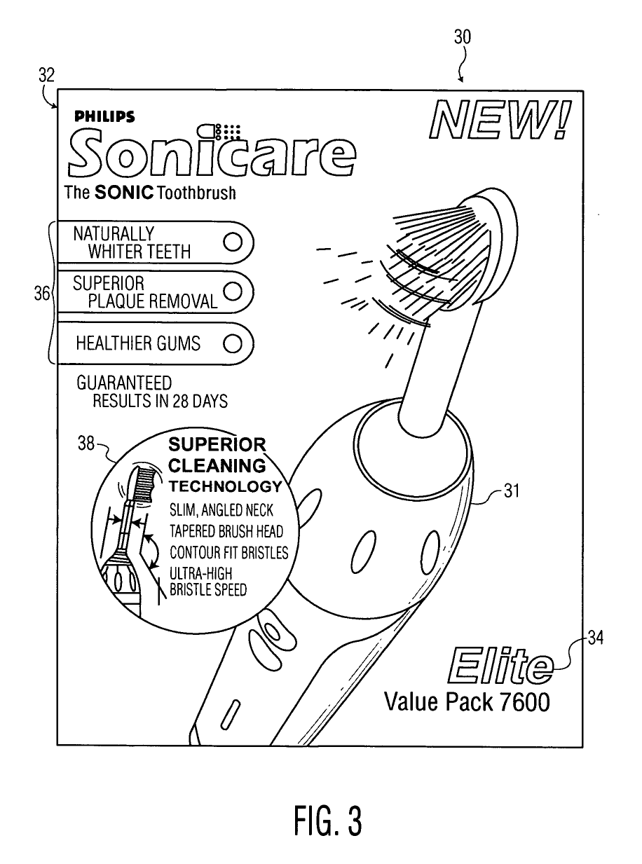

FIGS. 2 and 3 show the two “front panels” of the product packaging concept of the present invention, while FIG. 1 shows the use of the new product package in a pallet arrangement, illustrating the advantages thereof. A traditional front panel 10 is shown in FIG. 2, in terms of conventional product information (content) arrangement and illustrations concerning the product, generally designed to promote the product. The front panel 10 includes the trademark(s) for the product shown generally at 12, which could include the product trademark, a “house” or brand mark or marks, and even a slogan. The manufacturer of the product may also be shown.

A picture or drawing of the product is shown at 16, with a plurality of bullet-point features aligned to the right of the product, shown generally at 18. Alternatively, a clear plastic “bubble” or window portion could show the actual product inside the box (FIG. 2 shows this alternative). In the example of FIG. 1, a secondary trademark identifying the particular product is also on panel 10, shown generally at 20. Front panel 10 also includes a circular area 22, which includes a list of specific accessories in the package, in addition to the product itself. Below and to the left thereof are photographs or illustrations of the product with the accessories, shown at 24. The material described above on front panel 10 is a typical package front panel dominated by the product itself, but providing key introductory information about the product, to generate consumer interest.

Typically, a product package will have a back panel with some information about the product but will also include other, less pertinent information, including warranty information, for instance. The promotion of the product on the back panel is generally secondary to that of the front panel. Such back panel information may be helpful to the customer, but does not provide much if any promotional material relative to the product intended to generate interest in the product. For those reasons, the back panel of such boxes is usually not seen in a pallet arrangement.

In the present invention, the opposing panel (the panel of FIG. 2) on the box of the present invention, which would be the back panel in conventional arrangements, is in fact arranged and designed like a traditional front panel, with respect to its content, format and arrangement. It includes no information which would be contrary to the traditional appearance of a front panel. In the present arrangement, this is referred to as a second front panel. Referring now to FIG. 3, the second front panel 30 includes another picture or illustration 31 of the product, along with the principal or brand trademark or trademarks 32, the secondary or individual product trademark 34, a series of bullet points concerning the results/effects of the product at 36, and a circular highlight region at 38 which includes additional information about the product/product features. The second front panel 30 thus has an appearance, content and design arrangement of a conventional front panel, although it is in fact different and thus distinguishable from the first front panel 10.

The second front panel 30 is typically associated with the first front panel 10 by the use of identical trademarks, a picture of the product (or view of the actual product) and a generally similar design approach. In particular, the overall look/appearance and/or content of the two front panels are similar, complementing one another. It is possible, however, to have somewhat different design/content approaches between the two front panels. In one approach, the second front panel could actually be a continuation of or a part of the first front panel, so that the two front panels fit together to form a whole. The two panels could also be complementary, such that when the two panels are arranged side-by-side, a “billboard” effect results, the two panels jointly conveying key information about the product.

In another approach, the two panels could be quite different, to create interest in the product, involving perhaps substantially different appearances, content and design arrangements. In each case, however, both panels would look like a conventional front panel.

FIG. 1 shows a promotional pallet using the packaging concept of the present invention. The pallet 40 shows the use of a plurality of boxes 42-42 arranged with the two front panels of FIGS. 2 and 3 side-by-side. In the FIG. 1 arrangement, the sides 44-44 of the boxes are also part of the pallet. However, this is not necessary. The entire pallet could show only the two front panels. The pallet 40, with the two front panels being arranged side-by-side with complementary information, produce a “billboard” effect, conveying key information about the product. The promotional power of a conventional front panel is thus potentially at least doubled with the concept of the present invention.

Accordingly, a new product packaging concept has been shown and described, in which a product package has two “front” panels. The traditional back panel is replaced by another front panel. This provides an opportunity for key complementary information about the product from both front panels to be conventionally presented to the user in a pallet arrangement.

Although a preferred embodiment of the invention has been described for purposes of illustration, it should be understood that various changes, modifications and substitutions may be incorporated in the embodiment without departing from the spirit of the invention which is defined in the claims which follow.

1. A merchandising system for product packages, comprising:
a product package for a product, having a front side and an opposing rear side, wherein the content, format and design for both the front side and the rear side are like that of a conventional product package front panel, such that said product package gives the appearance of having two front panels instead of a front panel and a rear panel.

2. The system of claim 1, wherein the front and rear sides both show the product contained within the package.

3. The system of claim 2, wherein one side shows the product inside and the other side has an illustration or photograph of the product.

4. The system of claim 2, wherein both front and rear sides have an illustration/photograph of the product.

5. The system of claim 1, wherein both the front and rear sides have a trademark in the same relative position and approximately the same size and format.

6. The system of claim 1, wherein the front and rear sides both include significant promotional information concerning the product.

7. The system of claim 1, wherein the rear side has a similar content, format and arrangement as the front side.

8. The system of claim 1, wherein the front and rear sides present a complementary appearance and information when positioned side-by-side.

9. The system of claim 1, including a plurality of said product packages arranged into a pallet display system, in which the front and rear sides of the product package are arranged side-by-side.
